(19) United States
(12) Patent Application Publication
(10) Pub. No.: US 2002/0121744 A1
(43) Pub. Date: Sep. 5, 2002

(54) Low leakage flexible cloth seals for turbine combustors

(75) Inventors: Mahmut Faruk Aksit, Troy, NY (US); Jeffrey Arthur Benoit, Scotia, NY (US); Sami Aslam, Clifton Park, NY (US); Robert James Lloyd Bland, Oviedo, FL (US); Bharat Sampathkumaran Bagepalli, Niskayuna, NY (US)

Correspondence Address: GENERAL ELECTRIC COMPANY, CRD PATENT DOCKET ROOM 4A59, P O BOX 8, BUILDING K 1 SALAMONE, SCHENECTADY, NY, 12301, US

(73) Assignee: General Electric Company

(21) Appl. No.: 09/798,842

(22) Filed: Mar. 5, 2001

(51) Int. Cl. F16J 15/44

(52) U.S. Cl. 277/411

(57) ABSTRACT

Metallic cloth seals backed by stiff high temperature-resistant shims depend from a bracket for engagement in a slot of a transition piece for sealing between the transition piece and a first-stage nozzle. The high pressure acting on the shim forces the metallic cloth into engagement with the sealing surface in the slot. The lower edge of the shim is bent about, and overlies, the edge of the metallic cloth in a direction toward the sealing surface of the slot to choke any flow from the high pressure region past the seal. Elongated spline seals are also inserted into opposed registering slots of adjacent transition pieces. The spline seals comprise metallic cloth folded onto itself backed by elongated stiff high temperature-resistant shims having lateral edges overlying the lateral edges of the cloth material. The overlying edges prevent leakage flow about the spline seals from the high pressure to the low pressure regions.

### BACKGROUND OF THE INVENTION

This invention relates to flexible metallic cloth seals for gas turbine combustors and, more particularly, to seals having a composite structure formed from layers of wear-resistant metallic cloth and high-strength stiff sheet material forming shims which are extended to the sealing surface to choke or minimize leakage flow.

In conventional gas turbines, a plurality of combustors are arranged in an annular array about the axis of the turbine for supplying hot gases of combustion from the combustor through transition pieces and into the first-stage nozzle. Combustion systems of this type require seals that can tolerate relative motion between the components forming the sealing junction, for example, between the transition pieces and the first-stage nozzle. Conventional seals are designed to slide in slots machined into the adjoining parts. For example, the transition pieces have outwardly opening slots (generally perpendicular to the direction of gas flow through the transition pieces), while the first-stage nozzles have generally axially opening slots. Typically, a relatively rigid seal extends between the two generally perpendicularly arranged slots but has sufficient flexibility to accommodate relative motion between the parts. However, these relatively rigid seals tip or “toe” when a misalignment between the sealing parts occurs and this allows excess leakage flow through the seals.

Flexible brush and cloth seals have been developed to reduce leakage through joints such as those between transition pieces and first-stage nozzles. For example, see U.S. Pat. Nos. 5,474,306; 5,657,998; 5,915,697 and application Ser. No. 09/158,738, filed Sep. 22, 1998, of common assignee herewith. These flexible brush and cloth seals introduce substantial flexibility into the seal, enabling the seal to conform to the slot surface and hence reduce flow leakage rates when the adjoining surfaces are misaligned. One form of the cloth seals includes a metallic cloth folded over an internal stiff shim which provides some rigidity to the seal, yet provides sufficient flexibility upon relative movement of the sealed parts to maintain the cloth seal against its opposed sealing surface. However, due to the porous nature of the metallic cloth, some leakage flow can filter through the cloth layer between the shim and the slot surface about the edge of the seal.

Seals are also required between adjacent transition pieces. Elongated shims with metallic cloth folded over both sides of the shims have been provided for insertion into the registering slots along adjacent walls of the transition pieces. However, these elongated seals, similarly as the seals previously discussed between the transition pieces and the first-stage nozzle, afford some leakage flow through the cloth layer between the shim and the slot sealing surfaces. Accordingly, there is a need for a seal assembly which can substantially reduce this leakage flow.

### BRIEF SUMMARY OF THE INVENTION

In accordance with a preferred embodiment of the invention, a seal assembly is provided between turbine parts, e.g., between transition pieces of combustors and first-stage nozzles or between adjacent transition pieces, for precluding or minimizing leakage flow between high and low pressure regions on respective opposite sides of the seals. For sealing between each transition piece and a first-stage nozzle, a composite metallic woven or knitted cloth is provided for engaging against a sealing surface of a slot in the transition piece. On the high pressure side of the metallic cloth opposite the sealing surface, a stiff shim overlying the cloth provides structural support to the cloth, while the cloth provides sacrificial wear against the sealing surface without adding stiffness to the seal. Thus, the shim is placed on the high pressure side of the metallic cloth and an edge of the shim is bent over an edge of the cloth in a direction toward the sealing surface and thus overlies the edge of the cloth. By extending the edge of the shim about the edge of the sealing cloth toward the sealing surface, leakage flow between high and low pressure regions is choked, thereby minimizing or precluding leakage flow. Additionally, with the metallic shim on the high pressure side, the high pressure acts directly on the shim and maintains the cloth in sealing engagement against the sealing surface of the slot, adding increased flow resistance to the flow resistance afforded by the filtering cloth material.

In accordance with a further preferred embodiment of the invention, spline seals are also formed to minimize or prevent leakage flow between adjacent transition pieces. The lateral margins of the transition pieces have registering opposing slots. Each spline seal includes an elongated spline disposed in the registering slots. Particularly, the spline includes a metallic woven or knitted cloth material folded over onto itself with a stiff metallic shim extending along the high pressure side of the spline. The lateral edges of the shim are formed to overlie the respective lateral edges of the metallic cloth. Consequently, and similarly as the previously described seal, the overlying lateral edges of the shim choke the leakage flow through opposite lateral edges of the shim and through the metallic cloth seal material. The spline seals, of course, also seal between the adjacent seals which extend between the transition pieces and the first-stage nozzle.

In another preferred embodiment of the invention, a gas turbine includes a seal assembly for sealing between first and second parts of the turbine. The seal assembly includes a high temperature-resistant flexible material received in a slot in the first turbine part and having a surface engaging a wall of the first turbine part forming part of the slot to form a seal therewith, and a shim including a non-porous stiff sheet overlying a surface of the material opposite the surface of the material engaging the wall and overlying an edge of the material in the slot adjacent a base of the slot to preclude or minimize flow of fluid from a high pressure region on the shim side of the seal assembly past the seal and into a lower pressure region.

In a further preferred embodiment of the invention, a gas turbine includes a transition piece, a first-stage nozzle for receiving hot gases of combustion from a combustor, and a seal assembly extending between the transition piece and the first-stage nozzle. The seal assembly includes a high temperature-resistant flexible material received in a slot in the transition piece and having a surface engaging a wall of the transition piece forming the slot to form a seal therewith, and a shim including a non-porous stiff sheet overlying a surface of the material opposite the surface of the material engaging the wall and overlying an edge of the material in the slot adjacent a base of the slot to preclude or minimize flow of fluid from a high pressure region on the shim side of the seal assembly past the seal and into a lower pressure region.

In a still further preferred embodiment of the invention, a gas turbine includes a pair of adjacent transition pieces for receiving hot gases of combustion from combustors and flowing the hot gases into a first-stage turbine nozzle, the adjacent transition pieces having opposing side walls including registering slots, and a seal assembly for sealing between the adjacent transition pieces. The seal assembly includes a high temperature-resistant flexible material received in the slots of the adjacent transition pieces and engaging walls forming the slots to form respective seals with the walls, and a shim including a non-porous stiff sheet overlying a side of the material opposite sides of the material engaging the walls and overlying opposite edges of the material in the slots adjacent bases of the slots to preclude or minimize flow of a fluid from a high pressure region on the shim side of the seal assembly past the seal between the material and the slot walls and into a lower pressure region.

In a still further preferred embodiment of the invention, a gas turbine includes at least a pair of adjacent transition pieces and a first-stage nozzle for receiving hot gases of combustion from combustors, the transition pieces including outwardly opening first slots and opposed registering second slots, and first seal assemblies extending between the transition pieces and the first-stage nozzle. The first seal assemblies include high temperature-resistant flexible first materials received in the first slots of the transition pieces and having surfaces engaging walls of the first slots to form seals therewith, and shims including non-porous stiff sheets overlying surfaces of the first materials opposite the surfaces of the first materials engaging the first slot walls and overlying edges of the first materials in the slots adjacent bases thereof to preclude or minimize flow of fluid from a high pressure region on the shim side of the seal assemblies past the seal assemblies and into a lower pressure region. The gas turbine also includes a second seal assembly for sealing between the adjacent transition pieces, the second seal assembly including a second high temperature-resistant flexible material received in the second slots of the adjacent transition pieces and engaging walls forming the second slots to form respective seals with the walls, and a shim including a non-porous stiff sheet overlying a surface of the second material opposite surfaces of the second material engaging the walls of the second slots and overlying opposite edges of the second material in the second slots adjacent bases of the second slots to preclude or minimize flow of a fluid from the high pressure region on the shim side of the second seal assembly past the second seal assembly between the second material and the second slot walls and into the lower pressure region.

### BRIEF DESCRIPTION OF THE DRAWINGS

FIG. 1 is a fragmentary perspective view, with parts in cross-section, of a pair of adjacent transition pieces and a first-stage nozzle;

FIG. 2 is a fragmentary side elevational view of a seal assembly between a transition piece and a first-stage nozzle according to a preferred embodiment of the invention;

FIG. 3 is an enlarged fragmentary view of the edge of the seal assembly shown in FIG. 2;

FIG. 4 is a fragmentary perspective view with parts displaced from final positions relative to one another illustrating the seal assemblies between the transition pieces and the first-stage nozzle as well as between adjacent transition pieces;

FIG. 5 is a perspective view of a spline seal constructed in accordance with the invention;

FIG. 6 is an enlarged cross-sectional view of the spline seal of FIG. 4 located in the grooves of adjacent transition pieces; and

FIG. 7 is a view similar to FIG. 4 illustrating final assembly of the seal.

### DETAILED DESCRIPTION OF THE INVENTION

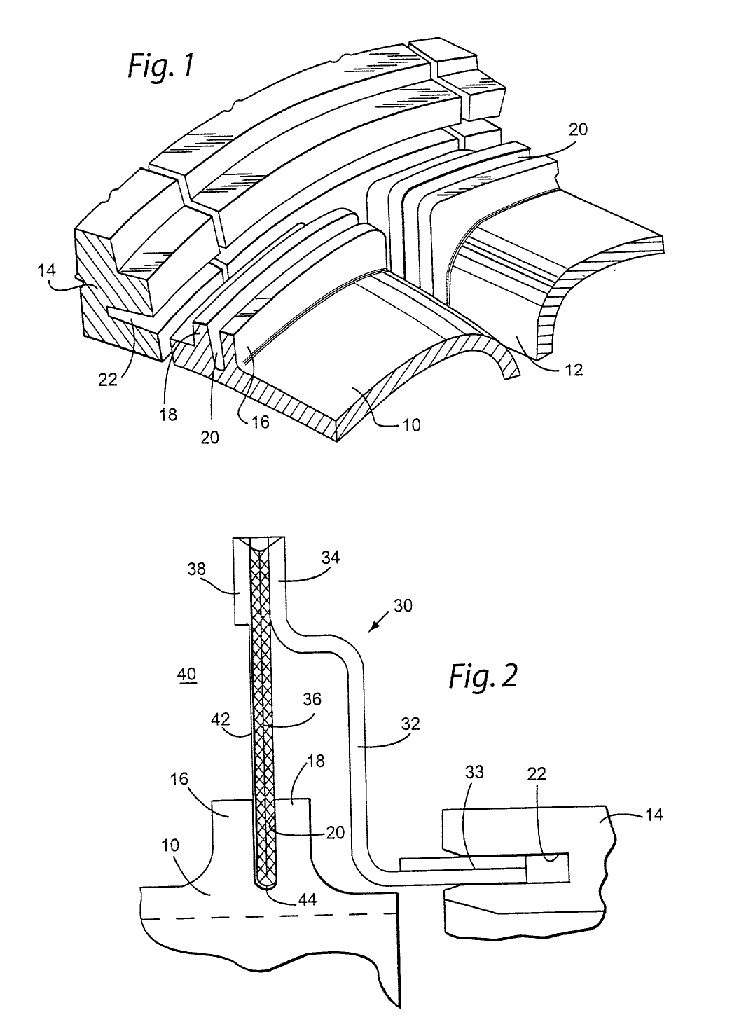

FIG. 1, illustrates a pair of adjacent transition pieces 10 and 12 and an annular interface forming part of a first-stage nozzle 14. It will be appreciated that there are a plurality of transition pieces arranged in an annular array thereof in communication with combustors for the gas turbine whereby the hot gases of combustion flow from the combustors through the transition pieces into the first-stage nozzle. The exit ends of the transition pieces are generally rectilinear passages for flowing the hot gases of combustion into the first-stage nozzle.

The transition pieces typically have a surrounding pair of flanges 16 and 18 defining a slot 20 therebetween. As illustrated in FIG. 1, slot 20 of each transition piece, for example, transition pieces 10 and 12, extends outwardly about side walls of the transition pieces generally perpendicularly to the flow of the hot combustion gases. The opposing slots of the adjacent transition pieces register laterally one with the other. Additionally, the annular interface of first-stage nozzle 14 has a generally annular slot 22 opening toward the combustor, i.e., in a generally axial direction relative to flow of the hot gases. Seal assemblies are typically provided between the transition pieces and the first-stage nozzle, with opposite edges of the seal assemblies residing in respective slots 20 and 22.

FIG. 2 illustrates a seal assembly 30, constructed in accordance with a preferred embodiment of the invention, extending between respective slots 20 and 22 of transition piece 10 and first-stage nozzle 14. Seal assembly 30 includes a generally arcuate extending bracket 32 bent at one end forming a edge 33 for reception in slot 22 of first-stage nozzle 14. The opposite edge 34 of bracket 32 extends generally perpendicularly to the flow of gases through the transition piece and overlies, and is secured to, the outer edge of a metallic cloth 36. Cloth 36 is preferably a woven or knitted metallic cloth. A retaining strip 38 is provided along the opposite side of metallic cloth 36 from bracket edge 34 and the outer edge of cloth 36 is sandwiched between and secured for example, by welding, to bracket edge 34 and retaining strip 38. Metallic cloth 36 depends from bracket 32 into slot 20 of transition piece 10. Metallic cloth 36 may comprise a single layer and preferably comprises a pair of layers folded one over the other, the foldline appearing along the lower edge of the cloth in slot 20. The cloth may comprise a high temperature-resistant material, such as metal, ceramic or polymer fibers which have been woven, knitted or pressed into a layer of fabric. If there are two layers of cloth, the multiple cloth layers may comprise different materials, a different layer construction or have different thicknesses, depending upon particular seal applications. Preferably, a Dutch twill weave cloth assemblage formed of a high temperature cobalt-based superalloy, such as L-605 or Hanes-25 may be utilized.

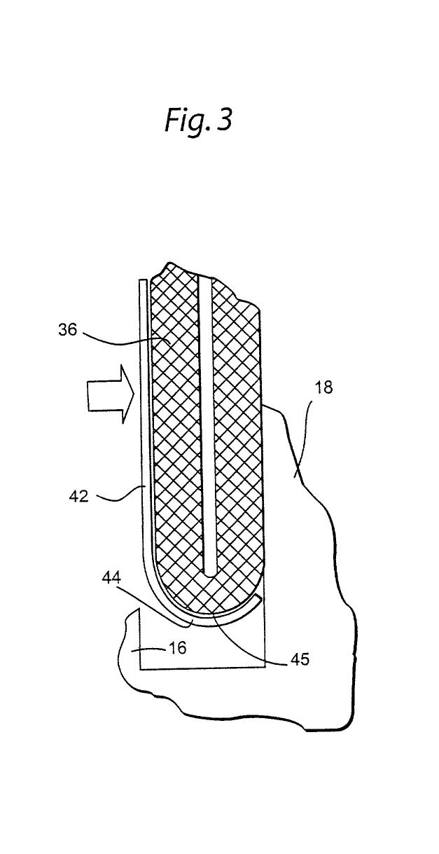

On the high pressure region or high pressure side 40 of the cloth seal, a stiff high temperature-resistant shim 42 is provided in the form of sheet material. The shim extends along the surface of metallic cloth 36 on the high pressure side and into slot 20 of the transition piece. As illustrated in FIGS. 2 and 3, lower edge 44 of shim 42 is extended or bent over lower edge 45 of metallic cloth 36 and extended to the sealing surface of slot 20, i.e., the face of flange 18, engaged by cloth 36 to provide enhanced flow resistance in addition to the resistance to flow afforded by the cloth. By forming the shim to overlie the lower edge of metallic cloth 36 in the slot, any flow from high pressure region 40 around the lower edge of cloth 36 to a lower pressure region on the opposite side of the seal assembly is choked, i.e., precluded or minimized. Moreover, by applying a shim in this form, added flow resistance on top of the resistance offered by the filtering cloth material is provided.

Shim 42 preferably comprises at least one layer but may comprise two superimposed identical layers of shim having staggered seams for added flexibility. Each shim layer may comprise a metal, ceramic or polymer sheet. For example, a shim layer may comprise a high temperature cobalt-based superalloy such as Inconel-750 or HS-188. The shim layers can comprise different materials and/or have different thicknesses, depending upon the particular seal application.

It will be appreciated that a plurality of seal assemblies 30 are provided about the annular array of transition pieces to accommodate relative movement of the transition pieces and the first-stage nozzle. The adjacent seal assemblies may abut one another in side-by-side relation. Spline seals are employed to seal between the opposed lateral edges of the transition pieces as well as to overlie the abutting surfaces of seal assemblies 30.

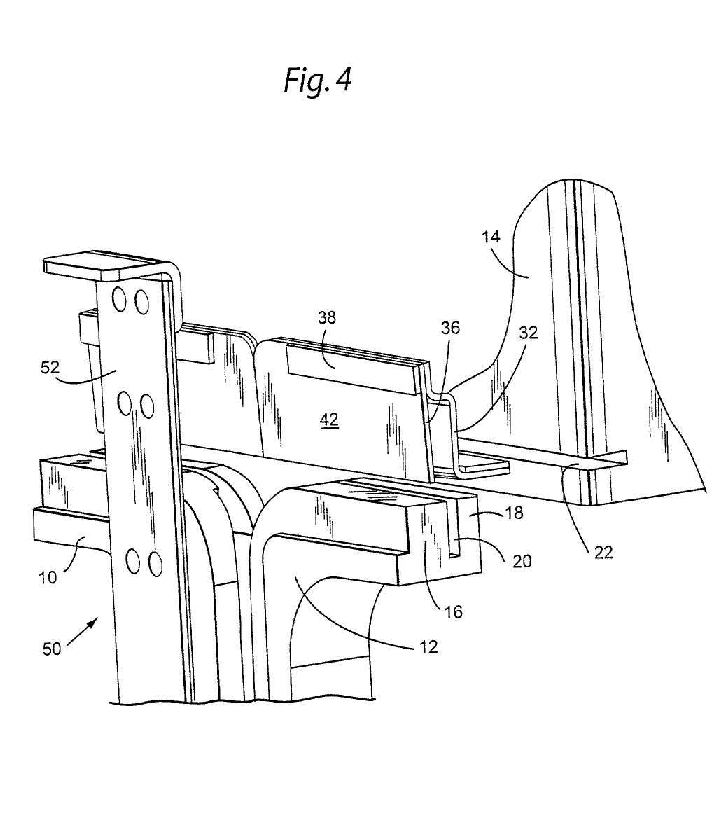

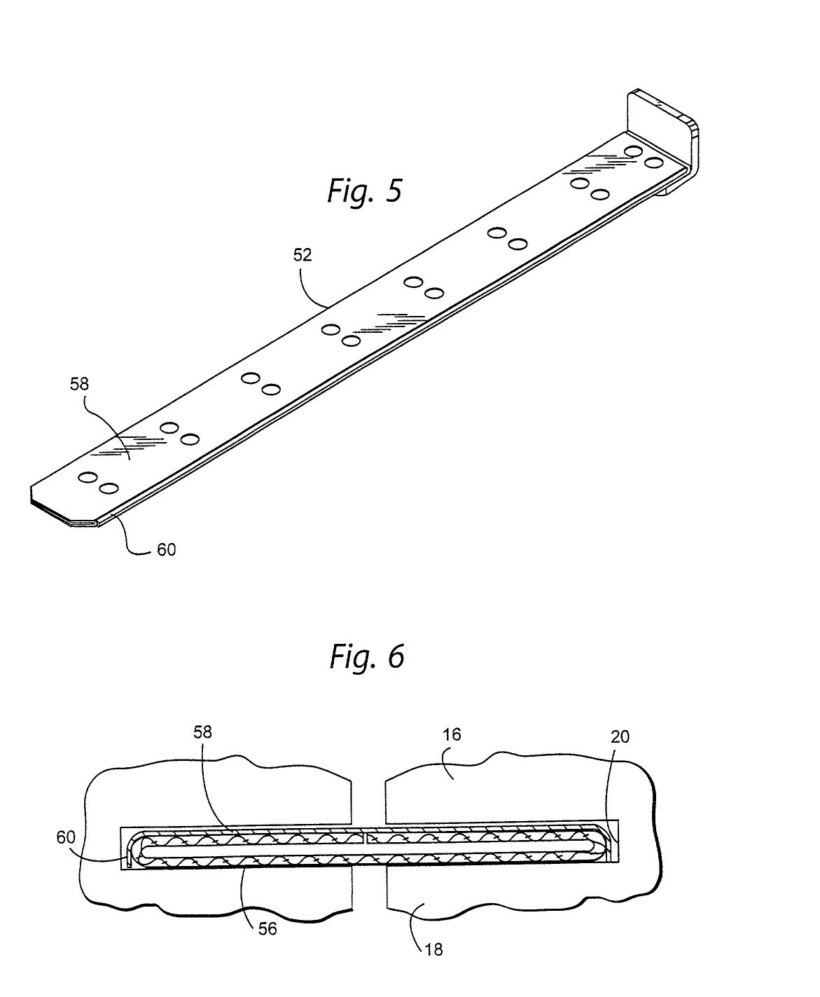

A spline seal 50, shown in FIG. 4, generally comprises an elongated member 52, as illustrated in FIG. 5, formed of a folded-over metallic cloth 56 and an elongate shim 58, as shown in FIG. 6. The metallic cloth and the shim of the elongated spline seals are formed of the same materials as the corresponding parts of seal assemblies 30 sealing between the transition pieces and the first-stage nozzle. As illustrated in FIGS. 5 and 6, the lateral edges 60 of each shim 58 overlie the lateral edges of metallic cloth 56 and extend to the sealing surfaces of the slots engaged by the exposed face of cloth 56. With the spline seals residing in the opposed registering slots 20 of adjacent transition pieces 10 and 12, and with the exposed surfaces of cloth 56 engaging the sealing surfaces of the slots on sides opposite the shims, it will be appreciated that the overlying lateral edges 60 of each shim 58 choke any leakage flow from the high-pressure region past the long edges of each shim into the filtering cloth material and beyond.

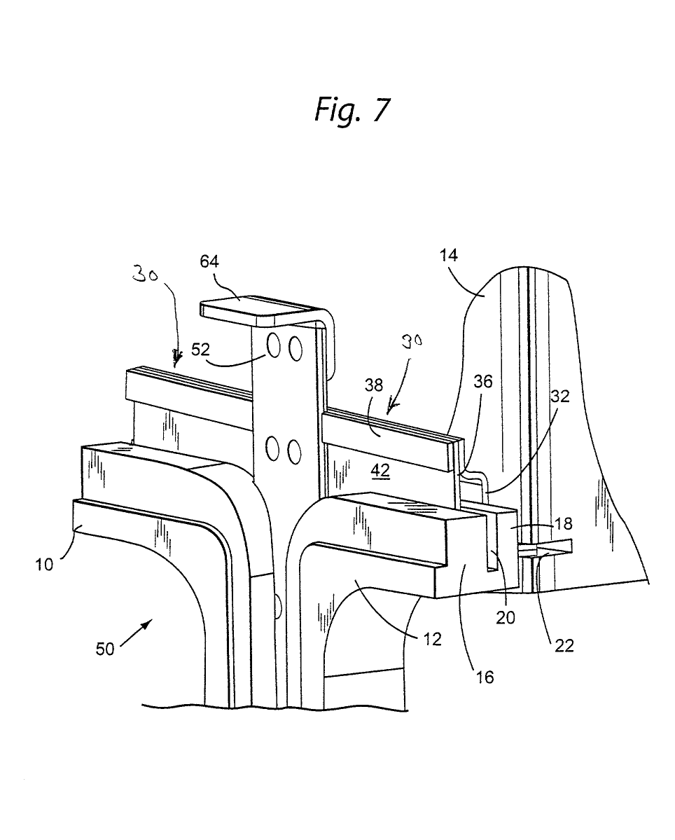

As illustrated in final assembly in FIG. 7, each spline seal 50 extends along the joint between adjacent seal assemblies 30. The strip 38 of each adjacent seal assembly 30 extends short of the lateral edge of the seal assembly 30 to accommodate the spline seal assembly 30 in final assembly. The bent tabs 64 of spline seals 50 are secured to the first-stage nozzle interface.

While only certain preferred features of the invention have been illustrated and described, many modifications and changes will occur to those skilled in the art. It is, therefore, to be understood that the appended claims are intended to cover all such modifications and changes as fall within the true spirit of the invention.

What is claimed is:

1. In a gas turbine having a first turbine part and a second turbine part, said first turbine part including a slot, a seal assembly for sealing between the first and second turbine parts, said seal assembly including:
a high temperature-resistant flexible material received in the slot of the first turbine part and having a surface engaging a wall of the first turbine part forming part of the slot to form a seal therewith; and
a shim including a non-porous stiff sheet overlying a surface of the material opposite the surface thereof engaging the wall and overlying an edge of the material in the slot adjacent a base of the slot to preclude or minimize flow of fluid from a high pressure region on the shim side of the seal assembly past the seal and into a lower pressure region.

2. A seal assembly according to claim 1 wherein the material comprises a metallic cloth.

3. A seal assembly according to claim 1 wherein said first turbine part includes a transition piece having said slot, said second turbine part including a first-stage nozzle having a slot, and said seal assembly including a bracket secured at one edge to said material and having an opposite edge received in said first-stage nozzle slot.

4. A seal assembly according to claim 3 including a reinforcing strip secured to said material on a side thereof opposite said one edge of said bracket.

5. A seal assembly according to claim 1 wherein the shim sheet, the material and the slot wall lie in generally parallel planes relative to one another.

6. A seal assembly according to claim 1 wherein said first turbine part and said second turbine part includes opposite side walls of adjacent first and second transition pieces of turbine combustors, said side walls of each of said first turbine part defining said slot and said sidewalls of said second turbine part including a registering slot, said material and said shim being elongated and received between said adjacent transition pieces with opposite elongated edges of said seal assembly extending in said slots, respectively, said material of said seal assembly engaging a wall of each of said transition pieces forming said slots to form seals therewith, opposite edges of said shim overlying respective edges of the material in the slots adjacent bases of said slots and extending toward said walls.

7. In a gas turbine having a transition piece and a first-stage nozzle for receiving hot gases of combustion from a combustor, said transition piece including a slot, a seal assembly extending between the transition piece and the first-stage nozzle including a high temperature-resistant flexible material received in the slot of the transition piece and having a surface engaging a wall of the transition piece forming the slot to form a seal therewith and a shim including a non-porous stiff sheet overlying a surface of the material opposite the surface of said material engaging the wall and overlying an edge of the material in the slot adjacent a base of the slot to preclude or minimize flow of fluid from a high pressure region on the shim side of the seal assembly past the seal and into a lower pressure region.

8. A seal assembly according to claim 7 wherein the material comprises a metallic cloth.

9. A seal assembly according to claim 7 wherein said first-stage nozzle includes a slot, said seal assembly including a bracket secured along one edge to said material and having an opposite edge received in said first-stage nozzle slot.

10. A seal assembly according to claim 9 including a reinforcing strip secured to said material on a side thereof opposite the one edge of said sealing bracket.

11. A seal assembly according to claim 7 wherein said sheet, said material and said slot wall lie in generally parallel planes relative to one another.

12. In a gas turbine having a pair of adjacent transition pieces for receiving hot gases of combustion from combustors and flowing the hot gases into a first-stage turbine nozzle, said adjacent transition pieces having opposing side walls including registering slots, a spline seal for sealing between said adjacent transition pieces including a high temperature-resistant flexible material received in the slots of the adjacent transition pieces and engaging walls forming said slots to form respective seals with said walls, and a shim including a non-porous stiff sheet overlying a side of the material opposite sides thereof engaging said walls and overlying opposite edges of said material in the slots adjacent bases of the slots to preclude or minimize flow of a fluid from a high pressure region on the shim side of the seal assembly past the seal between the material and said slot walls and into a lower pressure region.

13. A seal assembly according to claim 12 wherein the material comprises a metallic cloth.

14. In a gas turbine having at least a pair of adjacent transition pieces and a first-stage nozzle for receiving hot gases of combustion from combustors, said transition pieces including outwardly opening first slots and said nozzle including opposed registering second slots, first seal assemblies extending between the transition pieces and the first-stage nozzle including high temperature-resistant flexible first materials received in the first slots of the transition pieces and having surfaces engaging walls of the first slots to form seals therewith and shims including non-porous stiff sheets overlying surfaces of the first materials opposite the surfaces of said first materials engaging the first slot walls and overlying edges of the first materials in the slots adjacent bases thereof to preclude or minimize flow of fluid from a high pressure region on the shim side of the seal assemblies past the seal assemblies and into a lower pressure region, a second seal assembly for sealing between said adjacent transition pieces, said second seal assembly including a second high temperature-resistant flexible matenal received in the second slots of the adjacent transition pieces and engaging walls forming said second slots to form respective seals with said walls, and a shim including a non-porous stiff sheet overlying a surface of the second material opposite surfaces of the second material engaging said walls of said second slots and overlying opposite edges of said material in the second slots adjacent bases of the second slots to preclude or minimize flow of a fluid from the high pressure region on the shim side of the second seal assembly past the second seal assembly between the second material and said second slot walls and into the lower pressure region.

15. A gas turbine according to claim 14 wherein each of the first and second materials comprises a metallic cloth.

16. A gas turbine according to claim 14 wherein said first seal assemblies each includes a bracket secured along one edge to said first material and having an opposite edge received in said first-stage nozzle slot.
